(19) United States
(12) Patent Application Publication
(10) Pub. No.: US 2015/0360512 A1
(43) Pub. Date: Dec. 17, 2015

(54) Riveting Structure of Caster Wheel

(71) Applicant: Po-Chuan Tsai, Tainan City (TW)

(72) Inventor: Po-Chuan Tsai, Tainan City (TW)

(21) Appl. No.: 14/305,017

(22) Filed: Jun. 16, 2014

(51) Int. Cl. B60B 33/00

(52) U.S. Cl. CPC B60B 33/0068; B60B 33/0065

(57) ABSTRACT

A riveting structure of a caster wheel contains: a connecting mount, a wheel seat, and a coupling shaft. The connecting mount includes a central hole longitudinally defined at a central position thereof The wheel seat includes a horizontal orifice, a central groove, and an accommodating slot horizontally defined on a distal end of the central groove and communicating with the central groove to accommodate a peripheral rib extending around a distal end of a lower extension of the coupling shaft. The lower extension is inserted into the central groove so that the peripheral rib is retained in the accommodating slot of the wheel seat, an upper extension of the coupling shaft is inserted through the central hole of the connecting mount so that a top end of the upper extension of the coupling shaft is riveted in the connecting mount, thus connecting the connecting mount and the wheel seat together.

### FIELD OF THE INVENTION

The present invention relates to a riveting structure of a caster wheel which is assembled easily and quickly to save production cost and manufacturing time.

### BACKGROUND OF THE INVENTION

As shown in FIG. 1, a conventional riveting structure of a caster wheel contains: a connecting member 40 including a plurality of connection areas 41, a central hole 43 defined in the plurality of connection areas 41, and an end orifice 42 formed on a distal end of the central hole 43 to rivet with a caster wheel. In assembly, a coupling element 75 is inserted through a joining portion 72, a lower disc 83, a circular holding disc 82, an upper disc 81, and the central hole 43 of the connecting member 40 to rivet with a riveting element 76. However, such an assembly is complicated and time-consuming to cause high production cost.

The present invention has arisen to mitigate and/or obviate the afore-described disadvantages.

### SUMMARY OF THE INVENTION

The primary objective of the present invention is to provide a riveting structure of a caster wheel which is assembled easily and quickly to save production cost and manufacturing time.

Another objective of the present invention is to provide a riveting structure of a caster wheel which is assembled securely.

To obtain the above objectives, a riveting structure of a caster wheel provided by the present invention contains: a connecting mount, a wheel seat, and a coupling shaft.

The connecting mount includes a central hole longitudinally defined at a central position thereof; the wheel seat includes a horizontal orifice formed on a bottom end thereof, a central groove longitudinally arranged at a central position thereof, and an accommodating slot horizontally defined on a distal end of the central groove and communicating with the central groove to accommodate a peripheral rib extending around a distal end of a lower extension of the coupling shaft.

The lower extension of the coupling shaft is inserted into the central groove of the wheel seat so that the peripheral rib of the coupling shaft is retained in the accommodating slot of the wheel seat, and an upper extension of the coupling shaft is inserted through the central hole of the connecting mount so that a top end of the upper extension of the coupling shaft is riveted in the connecting mount, thus connecting the connecting mount and the wheel seat together.

### BRIEF DESCRIPTION OF THE DRAWINGS

FIG. 1 is a perspective view showing the exploded components of a conventional riveting structure of a caster wheel.

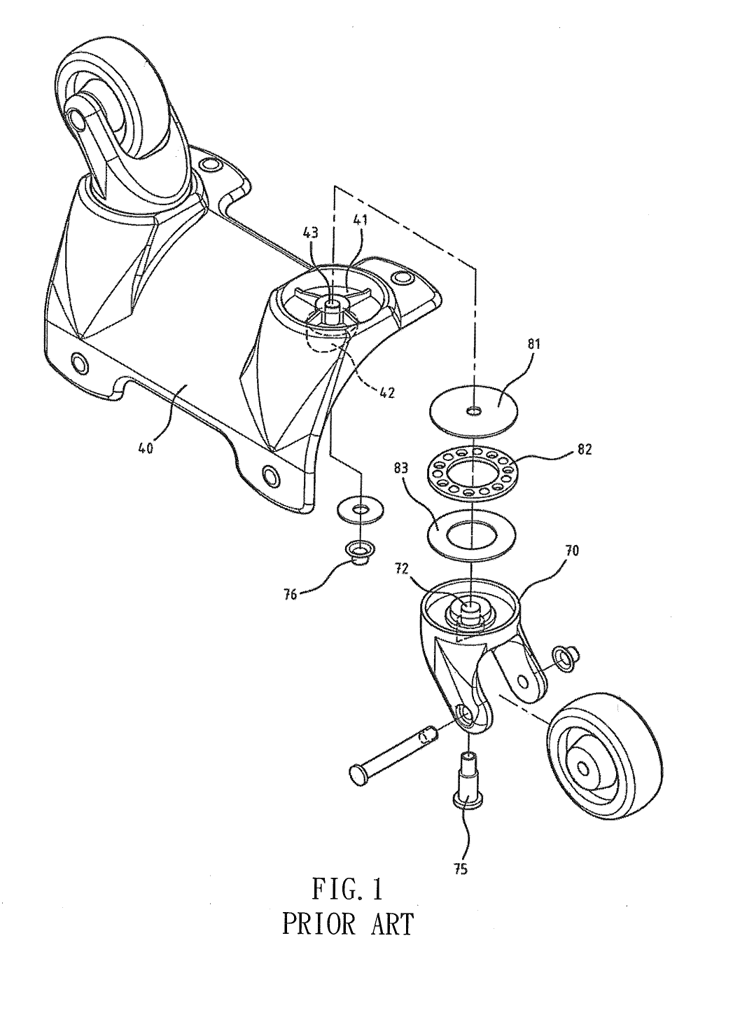

FIG. 2 is a perspective view showing the assembly of a riveting structure of a caster wheel according to a preferred embodiment of the present invention.

FIG. 3 is a perspective view showing the exploded components of the riveting structure of the caster wheel according to the preferred embodiment of the present invention.

FIG. 4 is a cross sectional view showing the assembly of the riveting structure of the caster wheel according to the preferred embodiment of the present invention.

### DETAILED DESCRIPTION OF THE PREFERRED EMBODIMENTS

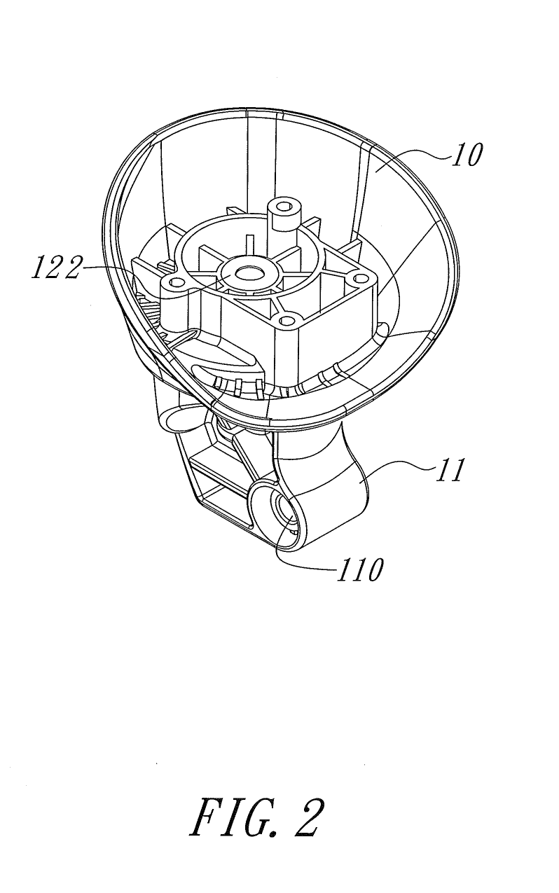

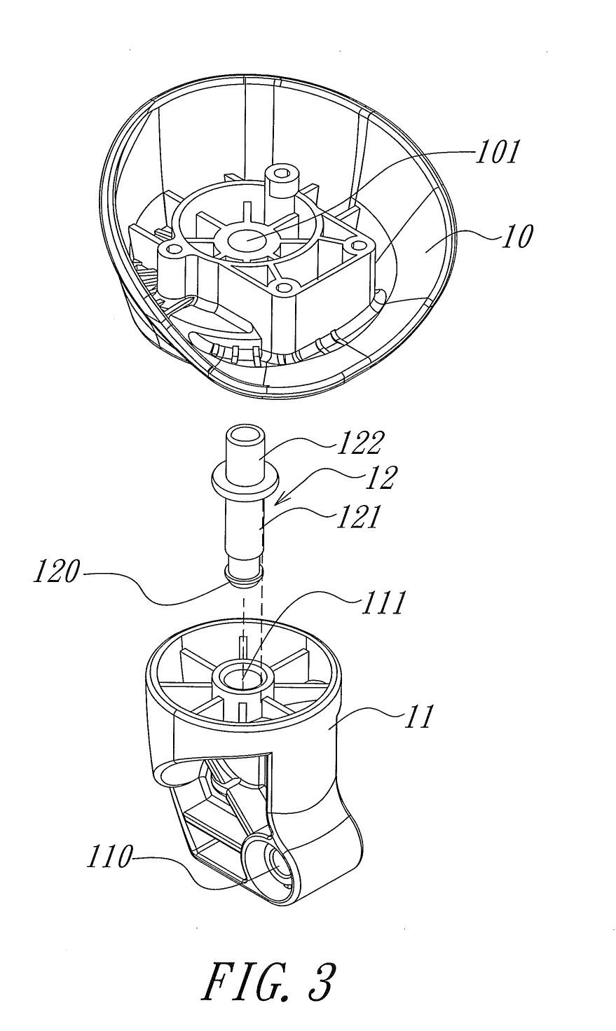

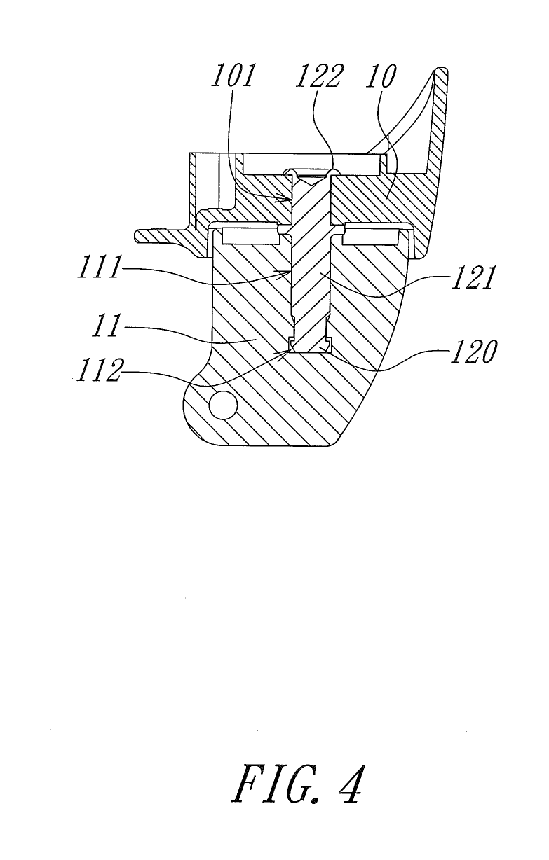

With reference to FIGS. 2 to 4, a riveting structure of a caster wheel according to a preferred embodiment of the present invention comprises: a connecting mount 10, a wheel seat 11, and a coupling shaft 12. The connecting mount 10 includes a central hole 101 longitudinally defined at a central position thereof; the wheel seat 11 includes a horizontal orifice 110 formed on a bottom end thereof, a central groove 111 longitudinally arranged at a central position thereof, and an accommodating slot 112 horizontally defined on a distal end of the central groove 111 and communicating with the central groove 111 to accommodate a peripheral rib 120 extending around a distal end of a lower extension 121 of the coupling shaft 12, such that the lower extension 121 of the coupling shaft 12 is inserted into the central groove 111 of the wheel seat 11 so that the peripheral rib 120 of the coupling shaft 12 is retained in the accommodating slot 112 of the wheel seat 11. Furthermore, an upper extension 122 of the coupling shaft 12 is inserted through the central hole 101 of the connecting mount 10 so that a top end of the upper extension 122 of the coupling shaft 12 is riveted in the connecting mount 10, thus connecting the connecting mount 10 and the wheel seat 11 together easily and securely.

While we have shown and described various embodiments in accordance with the present invention, it is clear to those skilled in the art that further embodiments may be made without departing from the scope of the present invention.

What is claimed is:

1. A riveting structure of a caster wheel comprising:
a connecting mount, a wheel seat, and a coupling shaft; the connecting mount including a central hole longitudinally defined at a central position thereof; the wheel seat including a horizontal orifice formed on a bottom end thereof, a central groove longitudinally arranged at a central position thereof, and an accommodating slot horizontally defined on a distal end of the central groove and communicating with the central groove to accommodate a peripheral rib extending around a distal end of a lower extension of the coupling shaft; characterized in that:
the lower extension of the coupling shaft is inserted into the central groove of the wheel seat so that the peripheral rib of the coupling shaft is retained in the accommodating slot of the wheel seat, and an upper extension of the coupling shaft is inserted through the central hole of the connecting mount so that a top end of the upper extension of the coupling shaft is riveted in the connecting mount, thus connecting the connecting mount and the wheel seat together.
